(19) United States
(12) Patent Application Publication
(10) Pub. No.: US 2023/0289657 A1
(43) Pub. Date: Sep. 14, 2023

(54) COMPUTER-READABLE RECORDING MEDIUM STORING DETERMINATION PROGRAM, DETERMINATION METHOD, AND INFORMATION PROCESSING DEVICE

(71) Applicant: Fujitsu Limited, Kawasaki-shi (JP)

(72) Inventor: Akira URA, Yokohama (JP)

(73) Assignee: Fujitsu Limited, Kawasaki-shi (JP)

(21) Appl. No.: 18/069,431

(22) Filed: Dec. 21, 2022

(30) Foreign Application Priority Data
Mar. 10, 2022 (JP) 2022-037362

(51) Int. Cl. G06N 20/00

(52) U.S. Cl. CPC G06N 20/00

(57) ABSTRACT

A program for causing a computer to execute processing including: generating division candidate datasets divided in accordance with different criteria from each other, from a combined dataset obtained by combining training data and validation data in a divided dataset that has been divided into the training data and the validation data used for machine learning; generating respective machine learning pipelines that execute machine learning, separately for each of the divided dataset and the division candidate datasets; using each of the divided dataset and the division candidate datasets to calculate respective prediction performances when the respective machine learning pipelines are executed; identifying division candidate datasets that have the prediction performances closest to the respective prediction performances calculated using the divided dataset, from among the division candidate datasets; and determining division criteria used for the identified division candidate dataset to be the division criteria used for the divided dataset.

### CROSS-REFERENCE TO RELATED APPLICATION

This application is based upon and claims the benefit of priority of the prior Japanese Patent Application No. 2022-37362, filed on Mar. 10, 2022, the entire contents of which are incorporated herein by reference.

### FIELD

The embodiments discussed herein are related to a determination program, a determination method, and an information processing device.

### BACKGROUND

In analysis using machine learning, when a dataset is given, the given dataset is usually divided into three datasets, namely, training data, validation data, and test data. Usually, it is frequent to split the test data from the dataset and then divide the remaining data into the training data and the validation data. In addition, there are cases where division into the training data and the validation data is performed a plurality of times, as in cross-validation.

The training data is the data used when a machine learning pipeline is created. The validation data is the data used for primary evaluation and is used mainly to compare diverse machine learning models. The test data is data for performing final evaluation of the selected machine learning model, using the validation data.

The purpose of machine learning is to train the relationship between features and objective variable and to predict the objective variable from features of new data. In addition, after selecting a machine learning pipeline using the training data and the validation data, “the training data and the validation data” are also trained collectively again when final evaluation is performed using the test data. Since precise evaluation of the division between “(training data+validation data) and (test data)” and the division between “training data and validation data” will be disabled unless the divisions are performed in the same method, the method for division is one, and the one method will be applied twice.

For example, there are cases where the training data and the validation data have already been divided using a division method with a certain criterion, but the division method is unknown due to diverse factors such as the change of analysts. In this case, when new data is added or when the training data is further divided into the training data and the validation data, it is desired to use the same division method as the certain division method. As an approach for identifying the certain division method, there is known an approach of generating a combined dataset by combining the training data and the validation data that have already been divided and dividing the combined dataset by diverse division methods to look for a division method that matches the original divided data.

Examples of the related art include Japanese Laid-open Patent Publication No. 2019-152964.

### SUMMARY

According to an aspect of the embodiments, there is provided a non-transitory computer-readable recording medium storing a determination program for causing a computer to execute processing. In an example, the processing includes: generating a plurality of division candidate datasets divided in accordance with different criteria from each other, from a combined dataset obtained by combining training data and validation data in divided dataset that has been divided into the training data and the validation data used for machine learning; generating respective machine learning pipelines that execute machine learning, separately for each of the divided dataset and the plurality of division candidate datasets; using each of the divided dataset and the plurality of division candidate datasets to calculate respective prediction performances, each of the respective prediction performances indicating a prediction performance when a corresponding machine learning pipeline of the respective machine learning pipelines is executed; identifying the division candidate datasets that have the prediction performances closest to the respective prediction performances calculated by using the divided dataset, from among the plurality of division candidate datasets; and determining division criteria used for the identified division candidate dataset to be the division criteria used for the divided dataset.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining an information processing device according to a first embodiment;

FIG. 2 is a diagram explaining a dataset used for machine learning;

FIG. 3 is a diagram explaining a reference technique;

FIG. 4 is a functional block diagram illustrating a functional configuration of the information processing device according to the first embodiment;

FIG. 5 is a diagram explaining a divided dataset;

FIG. 6 is a diagram explaining generation of division candidate datasets;

FIG. 7 is a diagram explaining determination of a division method;

FIG. 8 is a flowchart illustrating a processing flow;

FIG. 9 is a diagram explaining a usage scene 1;

FIG. 10 is a diagram explaining a usage scene 2; and

FIG. 11 is a diagram explaining a hardware configuration example.

### DESCRIPTION OF EMBODIMENTS

However, with the above-described technique, it is not practicable to identify the division method used for the divided data from among a plurality of division method candidates. For example, when the number of division method candidates is finite, the original division dataset sometimes does not match the data used in any division method, and additionally, the division often includes elements of random numbers, which will not allow the above-described technique to identify the division method accurately.

Note that automated machine learning (AutoML) or the like that automates data analysis has been used, but AutoML uses random division to divide data, and it is thus not feasible to identify the division method used for the divided data.

In addition, it is also conceivable to manually search for the division method, but manual data division is difficult, especially for beginners. For example, using information that is not supposed to be used when making predictions on the test data is called a “leak”, and when a leak is caused, the prediction performance will not be evaluated precisely, and the machine learning model may not be properly selected, sometimes resulting in degradation in prediction performance during services.

An object of one aspect is to provide a determination program, a determination method, and an information processing device capable of identifying a division method used to generate divided data used for machine learning.

Hereinafter, embodiments of a determination program, a determination method, and an information processing device disclosed in the present application will be described in detail with reference to the drawings. Note that the present embodiments will not be limited by the following embodiments. In addition, the embodiments may be appropriately combined with each other unless otherwise contradicted.

### First Embodiment

<Description of Information Processing Device>

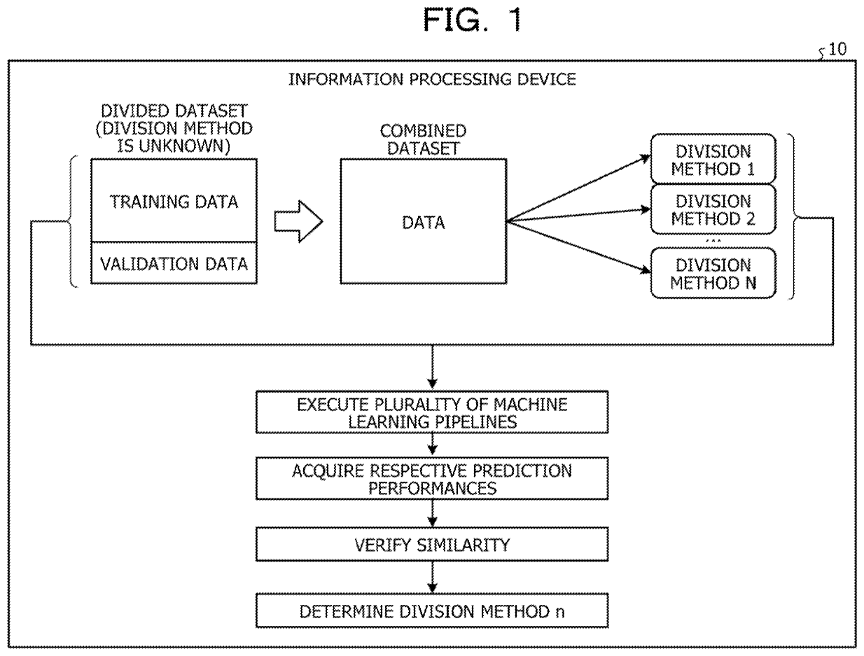

FIG. 1 is a diagram explaining an information processing device 10 according to a first embodiment. The information processing device 10 illustrated in FIG. 1 is an example of a computer device that, when given a divided dataset that has already been divided into training data and validation data in machine learning but for which the method itself for division is not known, selects a plausible division method from among a plurality of division method candidates by using the prediction performance of a plurality of machine learning pipelines corresponding to diverse division methods.

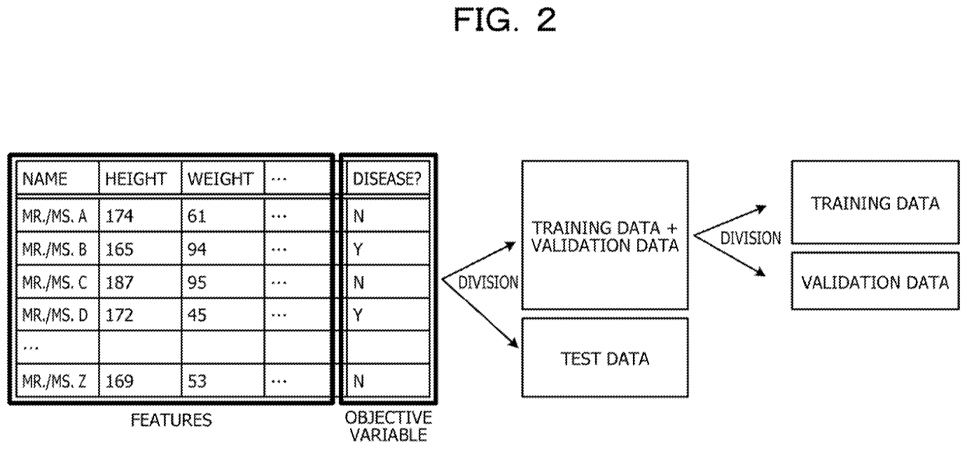

First, data used for machine learning will be described. FIG. 2 is a diagram explaining a dataset used for machine learning. As illustrated in FIG. 2, a dataset used for machine learning includes data including features and objective variables. In the example in FIG. 2, “name, height, weight, . . . ” are the explanatory variables, and the presence or absence of “disease” is the objective variable.

The purpose of machine learning is to train the relationship between features and objective variable and to predict the objective variable from features of new data. In addition, after selecting a machine learning pipeline using the training data and the validation data, “the training data and the validation data” are also trained collectively again when final evaluation is performed using the test data. Since precise evaluation of the division between “(training data+validation data) and (test data)” and the division between “training data and validation data” will be disabled unless the divisions are performed in the same method, the method for division is one, and the one method will be applied twice.

Here, in data division, division is performed in consideration of (1) date and time, (2) groups, and (3) distribution of the objective variable. For example, (1) date and time have a requirement that, when making predictions for a certain point in time, future information after the certain point in time is not permitted to be used. (2) Groups have a requirement that the training data and the validation data are not permitted to contain the same group. For example, when a machine learning model is used to predict sales for a new store, it is desired that store data in the test data is not included in the training data. Conversely, when sales of miscellaneous merchandise are predicted, it is not desired to consider stores. In (3) distribution of the objective variable, it is desirable that, in the case of a classification model, each label is included in the training data and the validation data in the same proportion, and for example, when there is a label having a small number of samples, division in consideration of labels is desired. In the case of a regression model, it is desirable that the training data and the validation data are close in distribution.

In this manner, since the method for data division has requirements to consider, it is important to identify a division method that satisfies (1), (2), and (3) above, and if the division method is imprecise, the accuracy of the machine learning model thereafter will also deteriorate.

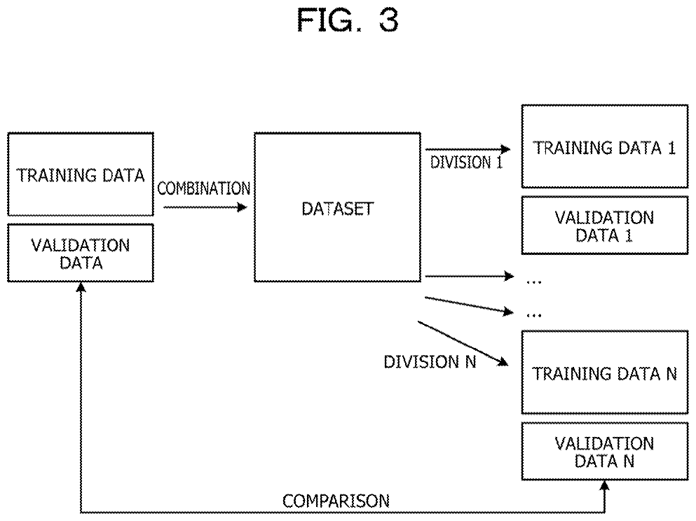

Next, a usually used reference technique for identifying a data division approach will be described. FIG. 3 is a diagram explaining a reference technique. As illustrated in FIG. 3, the reference technique generates a dataset obtained by temporarily combining the training data and the validation data in a given divided dataset. Then, in the reference technique, division datasets are generated by all division methods given in advance, and it is checked whether all the division datasets match the original division dataset.

For example, the reference technique generates a division dataset 1 obtained by dividing a dataset into training data 1 and validation data 1 using a division method 1, a division dataset 2 obtained by dividing the dataset into training data 2 and validation data 2 using a division method 2, and so forth. Thereafter, the reference technique compares the original division dataset with each of the division datasets 1 to N generated by each of the division methods 1 to N and, by searching for a matching division dataset, identifies the division method used for the original division dataset.

However, in the approach of the reference technique, when the candidates for division are assumed to be finite, there are cases where the original division dataset does not match any of the division datasets 1 to N in the first place, and the division often includes elements of random numbers. In addition, in the approach of the reference technique, when there is no perfect match, an index for evaluating which division is most plausible is not clear. Furthermore, even if the existing AutoML technique is used, whether random division is adopted is given as an input, and it is not feasible to select a plausible division method.

Thus, by focusing on that “the prediction performance can be evaluated similarly to given division” and “comparison results between a plurality of machine learning pipelines are similar to those in the given division”, the information processing device 10 according to the first embodiment identifies an unknown division method by trying a plurality of machine learning pipelines and regarding the division with which the machine learning pipelines has the closest prediction performances is correct.

For example, the information processing device 10 generates a combined dataset obtained by combining the training data and the validation data in a divided dataset that has been divided into the training data and the validation data used for machine learning but for which the division method is unknown. Then, the information processing device 10 uses the combined dataset to generate a plurality of division candidate datasets divided by each of the division methods 1 to N in accordance with different criteria from each other.

The information processing device 10 generates respective machine learning pipelines that execute machine learning, separately for each of the divided dataset and the plurality of division candidate datasets. The information processing device 10 uses each of the divided dataset and the plurality of division candidate datasets to calculate respective prediction performances when the respective machine learning pipelines are executed.

The information processing device 10 identifies a division candidate dataset that has the prediction performances closest to the respective prediction performances calculated using the divided dataset, from among the plurality of division candidate datasets, and determines the division criterion used for the identified division candidate dataset to be the division criterion used for the divided dataset for which the division method is unknown.

As a result, the information processing device 10 may identify the division method used to generate the divided data used for machine learning.

<Functional Configuration>

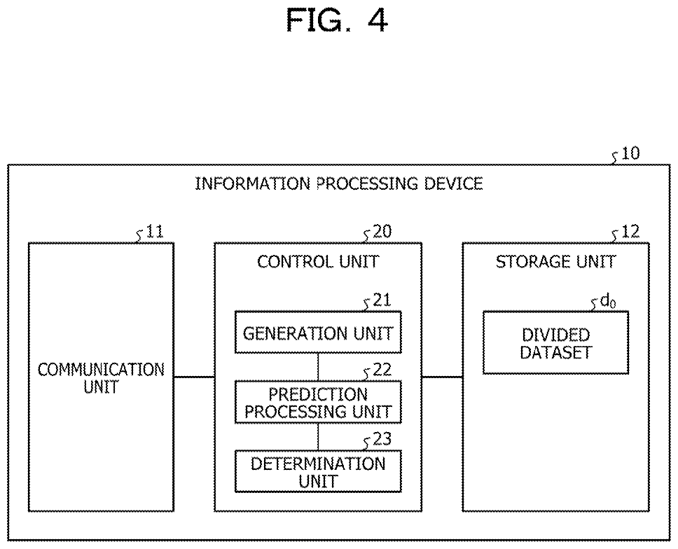

FIG. 4 is a functional block diagram illustrating a functional configuration of the information processing device 10 according to the first embodiment. As illustrated in FIG. 4, the information processing device 10 includes a communication unit 11, a storage unit 12, and a control unit 20.

The communication unit 11 is a processing unit that controls communication with another device and is implemented by, for example, a communication interface. For example, the communication unit 11 receives various instructions from a terminal of an administrator and transmits the processing result of the control unit 20 to the terminal of the administrator.

The storage unit 12 is a processing unit that stores various types of data, programs executed by the control unit 20, and the like and is implemented by a memory or a hard disk, for example. This storage unit 12 stores a divided dataset d₀.

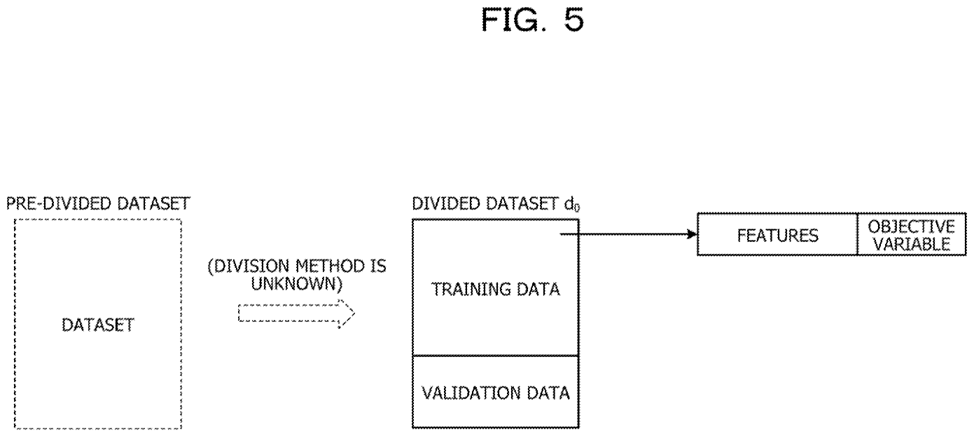

The divided dataset d₀ is a dataset used to train a machine learning model using a neural network or the like and is a dataset that has been divided into training data and validation data by a certain division method. FIG. 5 is a diagram explaining the divided dataset d₀. As illustrated in FIG. 5, the divided dataset d₀ is dataset obtained from a pre-divided dataset constituted by data including features and the objective variable, in which respective pieces of data in the dataset are divided into the training data and the validation data by a certain division method.

The control unit 20 is a processing unit that exercises overall control of the information processing device 10 and, for example, is implemented by a processor or the like. This control unit 20 includes a generation unit 21, a prediction processing unit 22, and a determination unit 23. Note that the generation unit 21, the prediction processing unit 22, and the determination unit 23 are implemented by an electronic circuit included in a processor, a process executed by the processor, or the like.

The generation unit 21 is a processing unit that generates a plurality of division candidate datasets divided in accordance with different criteria from each other, from a combined dataset obtained by combining the training data and the validation data in the divided dataset d₀ that has been divided into the training data and the validation data used for machine learning. Then, the generation unit 21 outputs generated division candidate datasets d₁ to d_{N} to the prediction processing unit 22.

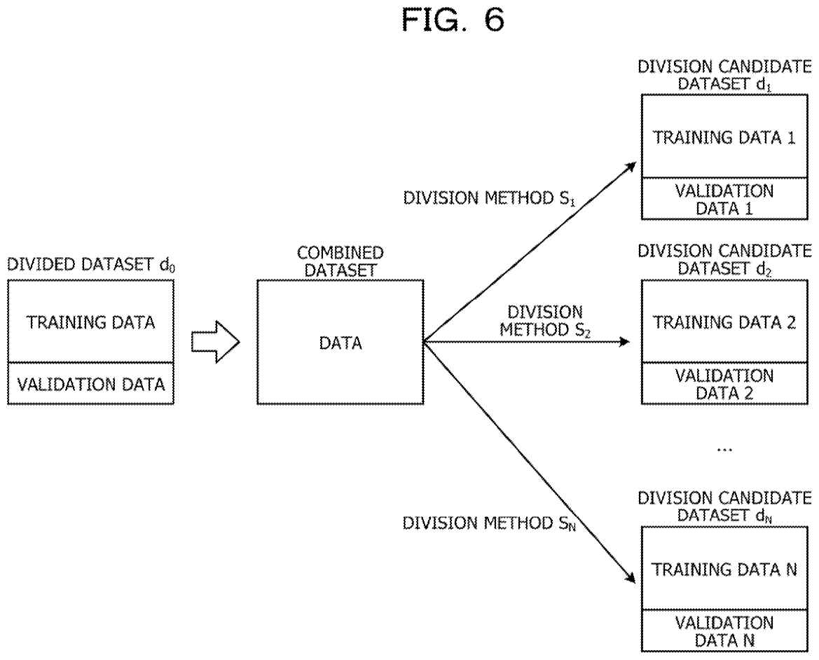

FIG. 6 is a diagram explaining generation of the division candidate datasets. As illustrated in FIG. 6, it is assumed that known division methods S₁ to S_{N} are given. In this case, the generation unit 21 uses the division method S₁ to generate the division candidate dataset d₁ divided into training data 1 and validation data 1 and uses the division method S₂ to generate the division candidate dataset d₂ divided into training data 2 and validation data 2.

For example, the division methods are the known division methods S₁ to S_{N} given in advance, such as random division and division based on numerical values set in columns. To give an example, the division method S₁ is an approach for generating the division candidate dataset d₁ by randomly dividing into the training data and the validation data. In addition, the division method S₂ is an approach for generating the division candidate dataset d₂ by dividing into the training data and the validation data such that the proportion of data of which the value of a column (for example, the height) is equal to or greater than a threshold value becomes similar to the proportion before the division. The division method S₃ is an approach for generating the division candidate dataset d₃ by dividing into the training data and the validation data such that the proportion of data of which the value of the first column (for example, the height) is less than a threshold value and the value of the second column (for example, the weight) is equal to or greater than a threshold value becomes similar to the proportion before the division. Note that the ratio of the training data and the validation data is assumed to be similar to the ratio in the divided dataset d₀ for which the division method is unknown, but that ratio is known.

The prediction processing unit 22 is a processing unit that generates respective machine learning pipelines that execute machine learning, separately for each of the divided dataset and the plurality of division candidate datasets, and calculates the respective prediction performances when the respective machine learning pipelines are executed, using each of the divided dataset and the plurality of division candidate datasets.

For example, the prediction processing unit 22 uses a technique such as AutoML to generate a machine learning pipeline P₀ corresponding to the divided dataset d₀. Similarly, the prediction processing unit 22 uses a technique such as AutoML to generate machine learning pipelines P₁ to P_{N} corresponding to the division candidate datasets d₁ to d_{N}, respectively. Note that the machine learning pipeline represents a series of processes including preprocessing including missing value interpolation, scaling, and the like and machine learning model generation.

The determination unit 23 is a processing unit that identifies a division candidate dataset that has the prediction performances closest to the respective prediction performances calculated using the divided dataset, from among the plurality of division candidate datasets, and determines the division criterion used for the identified division candidate dataset to be the division criterion used for the divided dataset.

For example, the determination unit 23 generates a first vector whose components are the respective prediction performances when each of the machine learning pipelines P₀ and P₁ to P_{N} is executed using the divided dataset d₀. Similarly, the determination unit 23 generates second vectors whose components are the respective prediction performances when each of the machine learning pipelines P₀ and P₁ to P_{N} is executed, for each of the plurality of division candidate datasets d₁ to d_{N}. Then, the determination unit 23 calculates the similarity between the second vectors separately corresponding to each of the plurality of division candidate datasets d₁ to d_{N} and the first vector and identifies the division candidate dataset corresponding to the second vector with the highest similarity, from among the plurality of division candidate datasets d₁ to d_{N}.

In addition, the determination unit 23 identifies the tendency of the respective prediction performances when each of the machine learning pipelines P₀ and P₁ to P_{N} is executed using the divided dataset d₀. Similarly, the determination unit 23 identifies the tendency of the respective prediction performances when each of the machine learning pipelines P₀ and P₁ to P_{N} is executed, for each of the plurality of division candidate datasets d₁ to d_{N}. Then, the determination unit 23 identifies a division candidate dataset having prediction performances of which the tendency is similar to the tendency of the respective prediction performances corresponding to the divided dataset d₀, from among the plurality of division candidate datasets d₁ to d_{N}.

### Specific Example

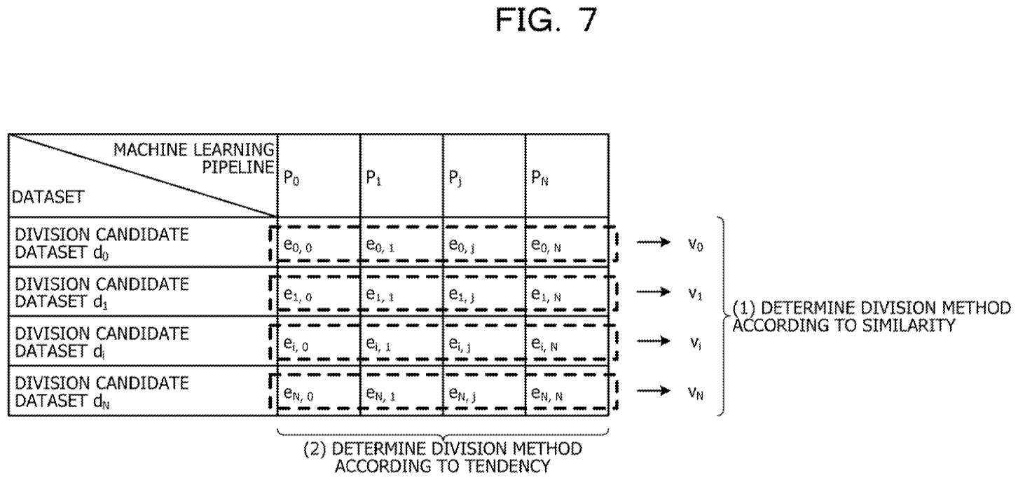

Here, a specific example of the above process of the determination unit 23 will be described with reference to FIG. 7. FIG. 7 is a diagram explaining determination of the division method. Note that, here, it is assumed that indices for the prediction performance, such as precision, recall, and correctness have been specified and set in advance as common information.

As illustrated in FIG. 7, for example, using the divided dataset d₀, the determination unit 23 identifies a prediction performance e_{0,0} when the machine learning pipeline P₀ is executed, a prediction performance e_{0,1} when the machine learning pipeline P₁ is executed, a prediction performance e_{0,j} when the machine learning pipeline Pⱼ is executed, and a prediction performance e_{0,N} when the machine learning pipeline P_{N} is executed.

Similarly, using the division candidate dataset d₁, the determination unit 23 identifies a prediction performance e_{1,0} when the machine learning pipeline P₀ is executed, a prediction performance e_{1,1} when the machine learning pipeline P₁ is executed, a prediction performance e_{1,j} when the machine learning pipeline Pⱼ, is executed, and a prediction performance e_{1,N} when the machine learning pipeline P_{N} is executed.

Similarly, using the division candidate dataset dᵢ, the determination unit 23 identifies a prediction performance e_{i,0} when the machine learning pipeline P₀ is executed, a prediction performance e_{i,1} when the machine learning pipeline P₁ is executed, a prediction performance e_{i,j} when the machine learning pipeline Pⱼ, is executed, and a prediction performance e_{i,N} when the machine learning pipeline P_{N} is executed.

Similarly, using the division candidate dataset d_{N}, the determination unit 23 identifies a prediction performance e_{N,0} when the machine learning pipeline P₀ is executed, a prediction performance e_{N,1} when the machine learning pipeline P₁ is executed, a prediction performance e_{N,j} when the machine learning pipeline Pⱼ, is executed, and a prediction performance e_{N,N} when the machine learning pipeline P_{N} is executed.

Then, the determination unit 23 generates a vector V₀ whose components are the prediction performance e_{0,0}, the prediction performance e_{0,1}, the prediction performance e_{0,j}, and the prediction performance e_{0,N} for the divided dataset d₀. Similarly, the determination unit 23 generates a vector V₁ whose components are the prediction performance e_{1,0}, the prediction performance e_{1,1}, the prediction performance e_{1,j}, and the prediction performance e_{1,N} for the division candidate dataset d₁. The determination unit 23 generates a vector V₁ whose components are the prediction performance e_{i,0}, the prediction performance e_{i,1}, the prediction performance e_{i,j}, and the prediction performance e_{i,N} for the division candidate dataset dᵢ. Similarly, the determination unit 23 generates a vector V_{N} whose components are the prediction performance e_{N,0}, the prediction performance e_{N,1}, the prediction performance e_{N,j}, and the prediction performance e_{N,N} for the division candidate dataset d_{N}.

Thereafter, as illustrated in (1) of FIG. 7, the determination unit 23 determines the division method used for the divided dataset d₀ according to the similarity. For example, the determination unit 23 uses the Euclidean distance or the like between vectors to calculate the similarity between V₀ and each of V₁, Vᵢ, and V_{N} and identifies Vᵢ with the highest similarity. As a result, the determination unit 23 determines the division method S₁ for the division candidate dataset d₁ corresponding to Vᵢ to be a division method S₀ used for the divided dataset d₀.

As another approach, as illustrated in (2) of FIG. 7, the determination unit 23 determines the division method used for the divided dataset d₀ according to the tendency of prediction performances. For example, the determination unit 23 calculates average values of the prediction performances for each division candidate dataset and determines a division method Sₙ for a division candidate dataset dₙ having an average value closest to the average value of the divided dataset d₀ to be the division method S₀ used for the divided dataset d₀.

In addition, the determination unit 23 identifies the order of respective prediction performances starting from the highest prediction performance for each division candidate dataset and determines the division method Sₙ for the division candidate dataset dₙ having the same order as the order of the divided dataset d₀ to be the division method S₀ used for the divided dataset d₀.

Furthermore, the determination unit 23 calculates the similarity between the prediction performance of the divided dataset d₀ and the prediction performance of the plurality of division candidate datasets d₁ to d_{N} for each of the machine learning pipelines P₀ and P₁ to P_{N}. For example, the determination unit 23 separately calculates the differences between the prediction performance e_{0,0} of the divided dataset d₀ and the respective prediction performances e_{0,0}, e_{1,0}, e_{i,0}, and e_{N,0} of the division candidate datasets d₁ to d_{N}. Then, the determination unit 23 identifies, for example, the division candidate dataset dₙ having an average value or variance of the differences less than a threshold value, or the division candidate dataset dₙ having the smallest difference between the maximum value and the minimum value of the differences. Then, the division method Sₙ for the identified division candidate dataset dₙ is determined to be the division method S₀ used for the divided dataset d₀.

Note that the determination unit 23, for example, outputs and displays the determined division method S₀ used for the divided dataset d₀ on a display or the like, or transmits the determined division method S₀ to the terminal of the administrator. In addition, the determination approaches (1) and (2) in FIG. 7 also can be combined with an AND condition and an OR condition.

<Processing Flow>

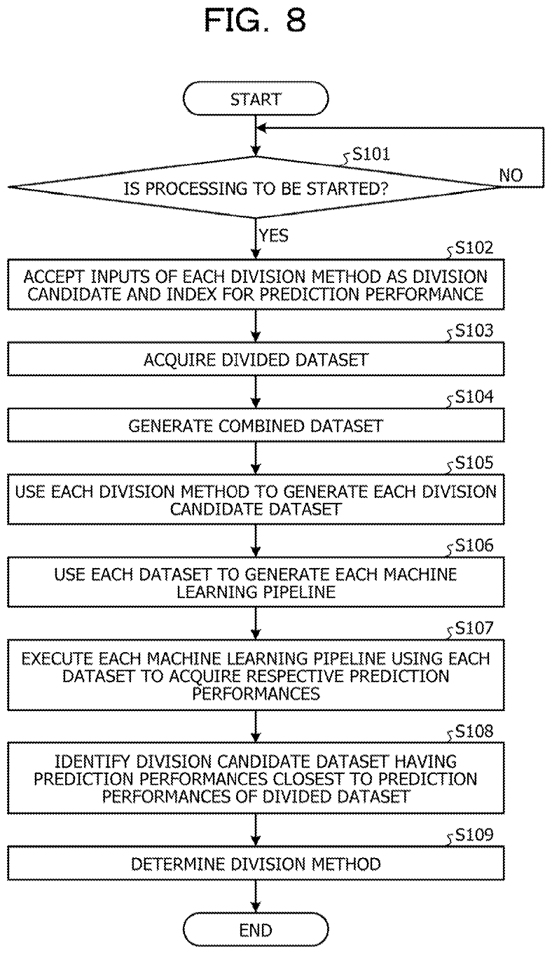

FIG. 8 is a flowchart illustrating a processing flow. As illustrated in FIG. 8, when instructed to start processing by an instruction from the administrator or at regular timing (S101: Yes), the control unit 20 of the information processing device 10 accepts inputs of each division method as a division candidate and an index for the prediction performance from the administrator or the like (S102).

Subsequently, the control unit 20 acquires the divided dataset d₀ from the storage unit 12 (S103) and generates a combined dataset obtained by combining the training data and the validation data in the divided dataset d₀ (S104).

Then, the control unit 20 uses each of the division methods S₁ to S_{N} to generate the division candidate datasets d₁ to d_{N} from the combined dataset (S105). Subsequently, the control unit 20 generates each of the machine learning pipelines P₀ and P₁ to P_{N} for each of the divided dataset d₀ and the division candidate datasets d₁ to d_{N} (S106).

Thereafter, the control unit 20 executes each of the machine learning pipelines P₀ and P₁ to P_{N} for each of the divided dataset d₀ and the division candidate datasets d₁ to d_{N} to acquire the respective prediction performances (S107).

Then, the control unit 20 identifies the division candidate dataset dₙ having the prediction performances closest to the prediction performances of the divided dataset d₀ (S108) and determines the division method Sₙ for the identified division candidate dataset dₙ to be the division method used for the divided dataset d₀ (S109).

<Effects>

As described above, when given a divided dataset including the objective variable, candidates for division, and an index for the prediction performance, the information processing device 10 according to the first embodiment may identify the division method used to generate the divided data from among the division candidates. In addition, since the information processing device 10 according to the first embodiment can identify the division method using the similarity of the prediction performances, the tendency of the prediction performances, and the like, the occurrence of a leak also may be suppressed, and a human error caused by manual operation also may be suppressed.

Furthermore, the information processing device 10 according to the first embodiment may achieve reduction of the time involved in identifying the division method, compared with comparison with all candidates as in the reference technique or manual identification. Additionally, since the information processing device 10 according to the first embodiment can identify the division method using objective information such as the prediction performance, the validity of the identified division method is high, and degradation in prediction performance during services after the machine learning using the identified division method also may be suppressed.

### Application Example 1

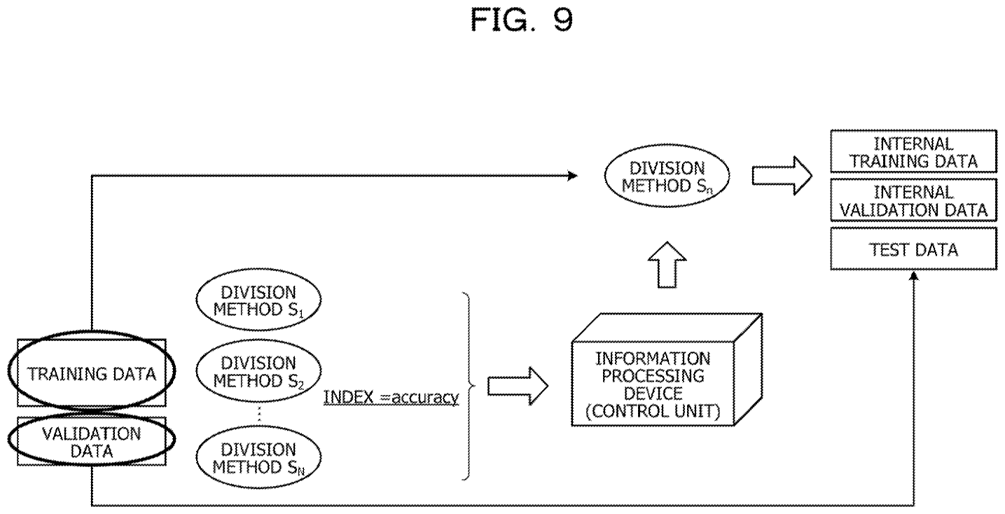

Next, an example of a usage scene of the division method identified using the approach according to the above first embodiment will be described. FIG. 9 is a diagram explaining a usage scene 1. As illustrated in FIG. 9, the information processing device 10 is given the divided dataset d₀ (the training data and the test data), the division methods S₁ to S_{N}, and an index for the prediction performance and identifies the division method Sₙ by the approach according to the first embodiment. Thereafter, when the training data of the divided dataset d₀ is further divided, the information processing device 10 divides the training data using the identified division method Sₙ. For example, the information processing device 10 divides the training data of the divided dataset do into internal training data and internal validation data, using the division method Sₙ.

As a result, the information processing device 10 can further divide the already existing training data into the training data and the test data and can treat the already existing validation data as test data. Therefore, the information processing device 10 may generate the training data and the validation data while ensuring the validity of the division method, for example, when the number of training targets increases.

### Application Example 2

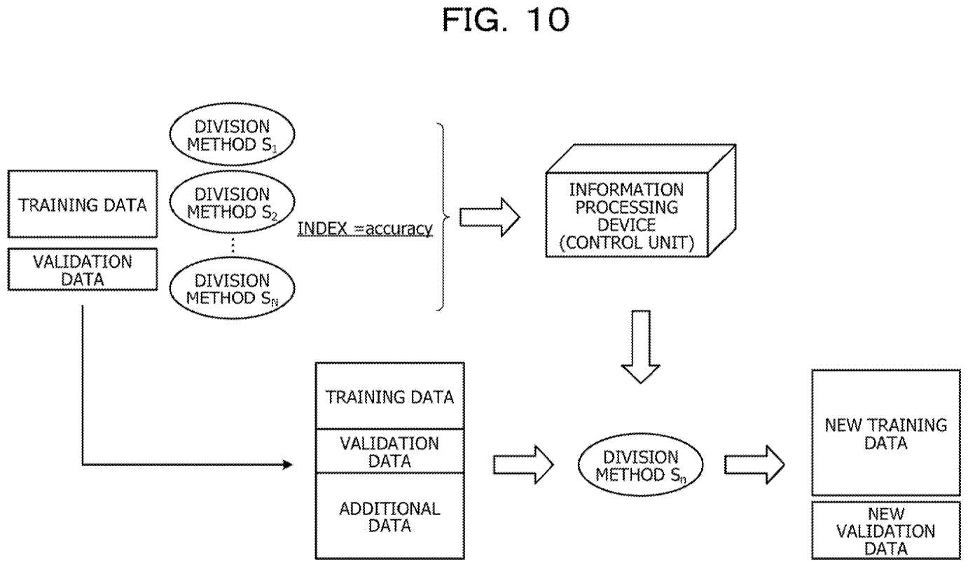

FIG. 10 is a diagram explaining a usage scene 2. As illustrated in FIG. 10, the information processing device 10 is given the divided dataset d₀ (the training data and the test data), the division methods S₁ to S_{N}, and an index for the prediction performance and identifies the division method Sₙ by the approach according to the first embodiment. Thereafter, when additional data is added to the divided dataset d₀, the information processing device 10 combines the training data, the validation data, and the additional data. Then, the information processing device 10 can divide the dataset that has been combined, into the training data and the validation data using the division method Sₙ, and execute machine learning of a machine learning model using these training data and validation data.

As a result, when supervised data is added to the divided dataset, the information processing device 10 may generate the training data and the validation data while ensuring the validity of the division method. Therefore, the information processing device 10 may also improve the accuracy of the machine learning model to be trained while increasing the amount of data for training by adding supervised data.

### Second Embodiment

Incidentally, while the embodiments have been described above, the embodiments may be carried out in a variety of different modes in addition to the embodiments described above.

<Numerical Values, Etc.>

The exemplary numerical values, exemplary data, column names, number of columns, number of pieces of data, and the like used in the embodiments described above are merely examples and may be optionally modified. In addition, the processing flow described in each flowchart may be appropriately modified unless otherwise contradicted. Each division method is an example of different criteria.

<System>

Pieces of information including the processing procedure, control procedure, specific name, and various types of data and parameters described above or illustrated in the drawings may be optionally modified unless otherwise noted.

Furthermore, each constituent element of each device illustrated in the drawings is functionally conceptual and does not necessarily have to be physically configured as illustrated in the drawings. For example, specific forms of distribution and integration of the respective devices are not limited to those illustrated in the drawings. For example, all or a part of the devices may be configured by being functionally or physically distributed or integrated in optional units according to various loads, use situations, or the like.

Moreover, all or any part of individual processing functions performed in each device may be implemented by a central processing unit (CPU) and a program analyzed and executed by the CPU or may be implemented as hardware by wired logic.

<Hardware>

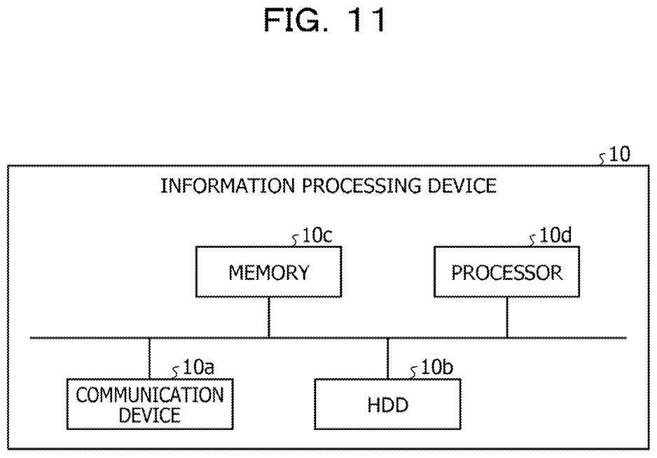

FIG. 11 is a diagram explaining a hardware configuration example. As illustrated in FIG. 11, the information processing device 10 includes a communication device 10a, a hard disk drive (HDD) 10b, a memory 10c, and a processor 10d. In addition, the respective units illustrated in FIG. 11 are mutually connected by a bus or the like.

The communication device 10a is a network interface card or the like and communicates with another device. The HDD 10b stores a program that activates the functions illustrated in FIG. 4, and a database (DB).

The processor 10d reads a program that executes processing similar to the processing of each processing unit illustrated in FIG. 4, from the HDD 10b or the like, and loads the read program into the memory 10c, thereby activating a process that executes each function described with reference to FIG. 4 and the like. For example, this process executes a function similar to the function of each processing unit included in the information processing device 10. For example, the processor 10d reads, from the HDD 10b or the like, a program having a function similar to the function of the generation unit 21, the prediction processing unit 22, the determination unit 23, and the like. Then, the processor 10d executes a process that executes processing similar to the processing of the generation unit 21, the prediction processing unit 22, the determination unit 23, and the like.

In this manner, the information processing device 10 works as an information processing device that executes an information processing method by reading and executing a program. In addition, the information processing device 10 may implement functions similar to the functions in the embodiments described above by reading the program described above from a recording medium with a medium reading device and executing the read program described above. Note that the program referred to in other embodiments is not limited to being executed by the information processing device 10. For example, the embodiments described above may be similarly applied also to a case where another computer or server executes the program or a case where these computer and server cooperatively execute the program.

This program may be distributed via a network such as the Internet. In addition, this program may be recorded in a computer-readable recording medium such as a hard disk, a flexible disk (FD), a compact disc read only memory (CD-ROM), a magneto-optical disk (MO), or a digital versatile disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program for causing a computer to execute processing comprising:
generating a plurality of division candidate datasets divided in accordance with different criteria from each other, from a combined dataset obtained by combining training data and validation data in a divided dataset that has been divided into the training data and the validation data used for machine learning;
generating respective machine learning pipelines that execute machine learning, separately for each of the divided dataset and the plurality of division candidate datasets;
using each of the divided dataset and the plurality of division candidate datasets to calculate respective prediction performances, each of the respective prediction performances indicating a prediction performance when a corresponding machine learning pipeline of the respective machine learning pipelines is executed;
identifying the division candidate datasets that have the prediction performances closest to the respective prediction performances calculated by using the divided dataset, from among the plurality of division candidate datasets; and
determining division criteria used for the identified division candidate dataset to be the division criteria used for the divided dataset.

2. The non-transitory computer-readable recording medium according to claim 1, wherein the identifying includes:
generating a first vector whose components are the respective prediction performances when the respective machine learning pipelines are executed by using the divided dataset;
generating each of second vectors whose components are the respective prediction performances when the respective machine learning pipelines are executed, for each of the plurality of division candidate datasets;
calculating similarity between each of the second vectors that one-to-one correspond to the plurality of division candidate datasets and the first vector; and
identifying the division candidate datasets that correspond to the second vectors with the highest similarity, from among the plurality of division candidate datasets.

3. The non-transitory computer-readable recording medium according to claim 1, wherein the identifying includes:
identifying a tendency of the respective prediction performances when the respective machine learning pipelines are executed by using the divided dataset;
identifying the tendency of the respective prediction performances when the respective machine learning pipelines are executed, for each of the plurality of division candidate datasets; and
identifying the division candidate datasets with the prediction performances of which the tendency is similar to the tendency of the respective prediction performances that correspond to the divided dataset, from among the plurality of division candidate datasets.

4. The non-transitory computer-readable recording medium according to claim 1, for causing the computer to execute the process comprising further dividing the training data into internal training data and internal validation data by using the determined division criteria.

5. The non-transitory computer-readable recording medium according to claim 1, for causing the computer to execute a process comprising:
generating an additional dataset obtained by newly adding additional data to the divided dataset that includes the training data and the validation data; and
dividing the additional dataset into the training data and the validation data by using the determined division criteria.

6. A determination method implemented by a computer, the determination method comprising:
generating, in a processor circuit of the computer, a plurality of division candidate datasets divided in accordance with different criteria from each other, from a combined dataset obtained by combining training data and validation data in a divided dataset that has been divided into the training data and the validation data used for machine learning;
generating, in the processor circuit of the computer, respective machine learning pipelines that execute machine learning, separately for each of the divided dataset and the plurality of division candidate datasets;
using, in the processor circuit of the computer, each of the divided dataset and the plurality of division candidate datasets to calculate respective prediction performances, each of the respective prediction performances indicating a prediction performance when a corresponding machine learning pipeline of the respective machine learning pipelines is executed;
identifying, in the processor circuit of the computer, the division candidate datasets that have the prediction performances closest to the respective prediction performances calculated by using the divided dataset, from among the plurality of division candidate datasets; and
determining, in the processor circuit of the computer, division criteria used for the identified division candidate dataset to be the division criteria used for the divided dataset.

7. An information processing apparatus comprising:
a memory; and
a processor coupled to the memory, the processor being configured to perform processing, the processing including:
generating a plurality of division candidate datasets divided in accordance with different criteria from each other, from a combined dataset obtained by combining training data and validation data in a divided dataset that has been divided into the training data and the validation data used for machine learning;
generating respective machine learning pipelines that execute machine learning, separately for each of the divided dataset and the plurality of division candidate datasets;
using each of the divided dataset and the plurality of division candidate datasets to calculate respective prediction performances, each of the respective prediction performances indicating a prediction performance when a corresponding machine learning pipeline of the respective machine learning pipelines is executed;
identifying the division candidate datasets that have the prediction performances closest to the respective prediction performances calculated by using the divided dataset, from among the plurality of division candidate datasets; and
determining division criteria used for the identified division candidate dataset to be the division criteria used for the divided dataset.
